(19) United States
(12) Patent Application Publication
(10) Pub. No.: US 2021/0385794 A1
(43) Pub. Date: Dec. 9, 2021

(54) METHOD AND DEVICE FOR WIRELESS COMMUNICATION

(71) Applicant: NTT DOCOMO, INC., Tokyo (JP)

(72) Inventors: Huan Wang, Beijing (CN); Yanru Wang, Beijing (CN); Xiaolin Hou, Beijing (CN); Shohei Yoshioka, Tokyo (JP)

(73) Assignee: NTT DOCOMO, INC., Tokyo (JP)

(21) Appl. No.: 17/287,248

(22) PCT Filed: Jan. 4, 2019
(86) PCT No.: PCT/CN2019/070493

§ 371 Date: Apr. 21, 2021

(51) Int. Cl. H04W 72/02

(52) U.S. Cl. CPC H04W 72/02; H04W 84/20

(57) ABSTRACT

The present application provides a method and device for wireless communication. A method performed by a communication device includes: acquiring a first parameter, so that the communication device determines whether the communication device can serve as a first-type communication device according to the first parameter, the first-type communication device being used to control a second-type communication device; and determining whether the communication device can serve as a first-type communication device at least according to the first parameter.

### TECHNICAL FIELD

The present disclosure relates to a field of wireless communication, and in particular, to a method and a device for wireless communication.

### BACKGROUND

In order to improve spectrum efficiency of a communication system, a Device-to-Device (D2D) communication technology has been proposed. In D2D communication, data may be directly transmitted between user terminals without through network-side devices such as base stations, thereby reducing latency, increasing network capacity, improving spectrum efficiency and the like.

In addition, in order to improve safety and intelligence of a transportation system, Vehicle to Everything (V2X) has been proposed. V2X requires low communication latency between vehicles, large network capacity and the like. Since D2D technology has significant advantages in latency, network capacity and the like, D2D technology is used as a basic support technology of V2X.

For V2X, a variety of allocation modes for transmission resources have been proposed, such as a base station-scheduling based resource allocation mode, a user terminal (which may be a car or a roadside unit in V2X) autonomous-selection resource allocation mode, or a user terminal-scheduling based resource allocation mode. In the user terminal-scheduling based resource allocation mode, a plurality of user terminals may form a user terminal group, and one of the plurality of user terminals serves as a header-user terminal (header-UE) while the remaining user terminals of the plurality of user terminals serve as member-user terminals (member-UEs), where the header-user terminal is used to control or schedule the member-user terminals. For example, the header-user terminal may allocate resources for the member-user terminals.

A user terminal may volunteer to be the header-user terminal. Therefore, there may be a situation where a plurality of user terminals volunteer to be the header-user terminal, and thus conflicts may occur.

### SUMMARY

According to one aspect of the present disclosure, a user terminal is provided, comprising: a control unit configured to acquire a first parameter, so that the user terminal determines whether it can serve as a first-type user terminal according to the first parameter, the first-type user terminal being used to control a second-type user terminal; the control unit being further configured to determine whether the user terminal can serve as a first-type user terminal at least according to the first parameter.

According to another aspect of the present disclosure, a method performed by a user terminal is provided, the method comprising: acquiring a first parameter, so that the user terminal determines whether it can serve as a first-type user terminal according to the first parameter, the first-type user terminal being used to control a second-type user terminal; and determining whether the user terminal can serve as a first-type user terminal at least according to the first parameter.

According to one example of the present disclosure, wherein the first parameter is a probability of the communication device serving as a first-type communication device.

According to one example of the present disclosure, wherein the determining whether the user terminal can serve as a first-type user terminal at least according to the first parameter includes: determining an actual probability of the communication device serving as a first-type communication device; determining that the user terminal can serve as a first-type user terminal when the actual probability is greater than the probability.

According to one example of the present disclosure, wherein the first parameter is a back-off time for the user terminal to serve as a first-type user terminal.

According to one example of the present disclosure, wherein the determining whether the user terminal can serve as a first-type user terminal at least according to the first parameter includes: determining that the user terminal can serve as a first-type user terminal when the back-off time is reduced to zero.

According to one example of the present disclosure, wherein the determining whether the user terminal can serve as a first-type user terminal at least according to the first parameter includes: determining that the user terminal cannot serve as a first-type user terminal when the user terminal receives notification information from a first-type user terminal before the back-off time is reduced to zero.

According to one example of the present disclosure, wherein when determining whether the user terminal can serve as a first-type user terminal at least according to the first parameter, the method further comprises: transmitting notification information to proximity user terminals of the user terminal, to notify the proximity user terminals that the user terminal serves as a first-type user terminal.

According to one example of the present disclosure, the above method further comprises: receiving a second parameter from other user terminals; wherein the determining whether the user terminal can serve as a first-type user terminal at least according to the first parameter includes: determining whether the user terminal can serve as a first-type user terminal according to the first parameter and the second parameter.

According to one example of the present disclosure, wherein the first parameter is attribute information of the user terminal, and the second parameter is attribute information of the other user terminals.

According to one example of the present disclosure, wherein when the attribute information of the user terminal includes identification information of the user terminal, the determining whether the user terminal can serve as a first-type user terminal according to the first parameter and the second parameter includes: determining that the user terminal can serve as a first-type user terminal when an identification value of the user terminal is greater than identification values of the other user terminals, or when the identification value of the user terminal is less than the identification values of the other user terminals.

According to one example of the present disclosure, wherein the determining whether the user terminal can serve as a first-type user terminal according to the first parameter and the second parameter includes: determining a priority for the user terminal to serve as a first-type user terminal according to the attribute information of the user terminal, and determine priorities for the other user terminals to serve as first-type user terminals according to the attribute information of the other user terminals; and determining that the user terminal can serve as a first-type user terminal when the priority for the user terminal to serve as a first-type user terminal is greater than the priorities for the other user terminals to serve as first-type user terminals.

### BRIEF DESCRIPTION OF THE DRAWINGS

The foregoing and other objectives, features and advantages of the present disclosure will become clearer from more detailed description of embodiments of the present disclosure in conjunction with accompanying drawings. The accompanying drawings are used to provide a further understanding of the embodiments of the present disclosure, constitute a part of this specification, and help to explain the present disclosure together with the embodiments of the present disclosure, but are not intended to act as a limitation of the present disclosure. In the accompanying drawings, like reference numerals usually indicate like components or steps.

FIG. 1 is a schematic diagram of a wireless communication system in which the embodiments of the present disclosure may be applied.

FIG. 2 is a flowchart of a method performed by a communication device according to a first embodiment of the present disclosure.

FIG. 3 is a schematic diagram of determining whether the communication device can serve as a first-type communication device according to a second implementation of the first embodiment of the present disclosure.

FIG. 4 is a flowchart of a method performed by a communication device according to a second embodiment of the present disclosure.

FIG. 5 is a schematic diagram of determining whether the communication device can serve as a first-type communication device according to the second embodiment of the present disclosure.

FIG. 6 is a schematic structural diagram of a communication device according to the first embodiment of the present disclosure.

FIG. 7 is a schematic structural diagram of a communication device according to the second embodiment of the present disclosure.

FIG. 8 is a schematic diagram of a hardware structure of a device involved in an embodiment of the present disclosure.

### DETAILED DESCRIPTION

In order to make objectives, technical solutions and advantages of the present disclosure clearer, exemplary embodiments according to the present disclosure will be described in detail below with reference to the accompanying drawings. Like reference numerals refer to like elements throughout the accompanying drawings. It should be understood that the embodiments described herein are merely illustrative and should not be constructed as limiting the scope of the present disclosure. User terminals described herein may include various types of user equipment (UEs), for example, mobile terminals (or referred to as mobile stations) or fixed terminals. However, for the sake of convenience, UEs and mobile terminals sometimes may be used interchangeably hereinafter.

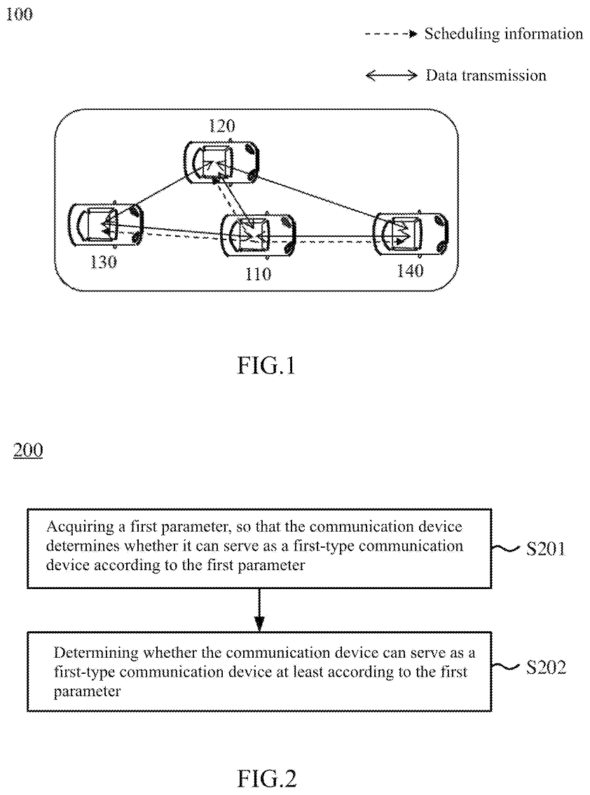

First, a wireless communication system in which the embodiments of the present disclosure may be applied will be described with referenced to FIG. 1. The wireless communication may be a 5G system, or may be any other type of wireless communication system such as an Long Term Evolution (LTE) system or an LTE-advanced (LTE-A) system. In the following, a 5G system is taken as an example to describe the embodiments of the present disclosure, but it should be appreciated that the following description may also be applied to other types of wireless communication systems.

As shown in FIG. 1, a wireless communication system 100 may include a first-type user terminal 110 and second-type user terminals 120, 130, 140. The first-type user terminal 110 and the second-type user terminals 120, 130, 140 may form a user terminal group, and the first-type user terminal 110 is used to control or schedule the second-type user terminals 120, 130, 140 in the user terminal group. For example, as shown by dashed lines in FIG. 1, the first-type user terminal 110 may transmit scheduling information to the second-type user terminals 120, 130, 140, respectively. Since the first-type user terminal 110 has the ability to control or schedule the second-type user terminals 120, 130, 140 in the user terminal group, the first-type user terminal 110 may also be referred as a header-user terminal, a control user terminal, a scheduling user terminal, a cluster header, a local manager, or any user terminal with control or scheduling capabilities. Accordingly, the second-type user terminals 120, 130, 140 may be referred to as member-user terminals, controlled user terminals, scheduled user terminals, cluster members, or any user terminals that are controlled or scheduled.

In addition, data transmission may be performed among user terminals in the user terminal group. For example, as shown by solid lines in FIG. 1, data transmission may be performed among the first-type user terminal 110, the second-type user terminal 120, the second-type user terminal 130, and the second-type user terminal 140.

It should be appreciated that although one first-type user terminal and three second-type user terminals are shown in FIG. 1, this is only illustrative, and the wireless communication system may include a plurality of first-type user terminals, and/or fewer or more second-type user terminals. Accordingly, the wireless communication system may include a plurality of user terminal groups.

In the communication system, a user terminal may volunteer to be the first-type user terminal. Therefore, at a certain moment, there may be a situation where a plurality of user terminals volunteer to be the first-type user terminal. A purpose of the present disclosure is to provide a method and a device for wireless communication, to avoid the situation where a plurality of user terminals volunteer to be the first-type user terminal as much as possible, and to determine the first-type user terminal from the plurality of user terminals volunteer when the plurality of user terminals volunteer to be the first-type user terminal.

In the embodiments of the present disclosure, the user terminals may be user terminals (pre)configured to camp on a resource pool (pre)configured for a Medium Access Control (MAC) structure corresponding to the user terminal-scheduling based resource allocation mode. In this disclosure, these user terminals may be referred to as candidate first-type user terminals. Furthermore, the candidate first-type user terminals may also be user terminals that do not belong to any user terminal group (for example, are not associated with any user terminal group, or are not associated with any first-type user terminal, etc.), and have not yet served as the first-type user terminals.

It should be appreciated that, although it is described above that the first-type user terminal and the second-type user terminals are all user terminals, the present disclosure is not limited thereto. The first-type user terminal and the second-type user terminals may also be communication devices on the network side, such as base stations. For example, the first-type user terminal may be a base station, and the second-type user terminals may be user terminals. Therefore, the terms “user terminal”, “first-type user terminal” and “second-type user terminal” may be replaced with “communication device”, “first-type communication device” and “second-type communication device”. Hereinafter, the terms “communication device”, “first-type communication device” and “second-type communication device” will be taken as examples to describe the embodiments of the present disclosure.

A method performed by a communication device according to a first embodiment of the present disclosure will be described below with reference to FIG. 2. FIG. 2 is a flowchart of a method 200 performed by a communication device according to the first embodiment of the present disclosure. As shown in FIG. 2, in step S201, the communication device acquires a first parameter, so that the communication device determines whether it can serve as a first-type communication device according to the first parameter, where the first-type communication device is used to control a second-type communication device. Then, in step S202, the communication device determines whether the communication device can serve as a first-type communication device at least according to the first parameter.

According to a first implementation of the first embodiment of the present disclosure, the first parameter may be a probability (or may also be referred to as a probability value) of the communication device serving as the first-type communication device.

According to one example of the first implementation, the probability may be a probability defined by communication standard protocol specifications such as 3GPP and the like. For example, the probability may be 10%, 20%, or 50%.

According to another example of the first implementation, the probability may also be a (pre)configured probability. For example, the probability may be written into a SIM card of the communication device, or a probability configured by a base station after the communication device accesses the base station. For example, the probability may be 10%, 20%, or 50%.

According to another example of the first implementation, the probability may be a probability selected from a probability range defined by communication standard protocol specifications such as 3GPP and the like or a (pre)configured probability range. For example, the communication device may randomly select a probability from the probability range as the probability of the communication device serving as the first-type communication device. For example, the probability range may be 20%˜60%, and the communication device may select 40% from the probability range as the probability of the communication device serving as the first-type communication device.

According to another example of the first implementation, the probability may be acquired based on a preset rule. The preset rule may be a preset function for the communication device, such as a utility function. An input of the utility function may be attribute information of the communication device, and an output of the utility function may be associated with the probability.

The attribute information of the communication device mentioned herein may include identification information of the communication device, for example, one or more of ID of the communication device, Service Set Identifier (SSID), Radio Network Temporary Identity (RNTI) and the like.

Furthermore, the attribute information of the communication device may also include movement information of the communication device, for example, one or more of an average speed, a maximum speed and the like of the communication device.

Furthermore, the attribute information of the communication device may also include location information of the communication device, for example, one or more of a geographic location (such as an absolute location or an area ID, etc.) of the communication device, a relative location between the communication device and a proximity communication device that does not belong to any communication device group, an average distance between the communication device and proximity communication devices that do not belong to any communication device group, and the like. In the present disclosure, the proximity communication device may be determined by the communication device performing signal measurement on another communication device. For example, the communication device performs signal measurement on another communication device to obtain a measurement result (for example, signal received quality), and when the measurement result is greater than a first threshold, the another communication device may be the proximity communication device of the communication device. In addition, the proximity communication device may also be determined according to locations of the communication device and another communication device. For example, when a linear distance between the communication device and another communication device is less than a predetermined threshold, the another communication device may be the proximity communication device of the communication device.

Furthermore, the attribute information of the communication device may also include a measurement/sensing result of the communication device on a proximity communication device that does not belong to any communication device group. The measurement/sensing result may be, for example, one or more of Reference Signal Receiving Power (RSRP), Received Signal Strength Indication (RSSI), Reference Signal Receiving Quality (RSRQ), Signal to Interference plus Noise Ratio (SINR), Signal to Noise Ratio (SNR) and the like.

Furthermore, the attribute information of the communication device may also include information about the number of proximity communication devices that do not belong to any communication device group, for example, information about the number of proximity communication devices that do not belong to any communication device group during a predetermined period of time.

Furthermore, the attribute information of the communication device may also include priority information for the communication device to serve as a first-type communication device. For example, a priority may be defined based on a determination manner of the first-type communication device. For example, when the first-type communication device is determined through high layer signaling, the priority for the communication device to serve as a first-type communication device may be set to 1; when the first-type communication device is (pre)configured, the priority for the communication device to serve as a first-type communication device may be set to 2; when the first-type communication device is automatically selected, the priority for the communication device to serve as a first-type communication device may be set to 3.

Furthermore, the attribute information of the communication device may also include class information of the communication device, for example, a class identifier of the communication device, such as a class identifier of the communication device belonging to a bus, a truck, a car or the like.

It should be appreciated that although the above examples describe that the attribute information of the communication device may include the identification information of the communication device, the movement information of the communication device, the location information of the communication device, the measurement/sensing result of the communication device on a proximity communication device that does not belong to any communication device group, the information about the number of proximity communication devices that do not belong to any communication device group, the priority information for the communication device to serve as a first-type communication device, or the class information of the communication device, the present disclosure is not limited thereto. According to other examples, the attribute information of the communication device may also include any other attribute information of the communication device.

In the first implementation, when the probability of the communication device serving as the first-type communication device is acquired based on the utility function, the probability of the communication device serving as the first-type communication device may have a corresponding relationship with the output of the utility function. Therefore, after the output of the utility function is determined, the probability of the communication device serving as the first-type communication device may be acquired by the corresponding relationship between the two.

Specifically, the output of the utility function may be determined firstly according to the following formula (1):

U=α·ƒ(ν)+b·ƒ(SNR) Formula (1)

wherein α and b represent weight parameters, ν represent a speed of the communication device, ƒ(ν) represents a function about the speed of the communication device, SNR represents a signal-to-noise ratio measured by the communication device to a proximity communication device, and ƒ(SNR) represents a function about the SNR of the communication device. It should be appreciated that although in the above formula (1), only the speed of the communication device and the signal-to-noise ratio measured by the communication device to a proximity communication device are used as inputs of the utility function, the present disclosure is not limited thereto. According to other examples, one or more other attributes of the communication device may also be used as inputs of the utility function. For example, the identification of the communication device, the class of the communication device and the like may also be used as inputs of the utility function.

Then, the probability of the communication device serving as the first-type communication device may be determined according to the corresponding relationship between the output of the utility function and the probability of the communication device serving as the first-type communication device. For example, the corresponding relationship between the outputs of the utility function and the probabilities of the communication device serving as the first-type communication device may be predefined, and thus the probability of the communication device serving as the first-type communication device may be determined by the output of the utility function and the corresponding relationship.

In addition, the corresponding relationship between the outputs of the utility function and the probabilities of the communication device serving as the first-type communication device may be stored in the communication device in the form of a table. Therefore, the communication device may determine its probability of serving as the first-type communication device by looking up the table after determining the output of the utility function. For example, the following Table 1 shows an example of the corresponding relationship between the outputs of the utility function and the probabilities of the communication device serving as the first-type communication device.

TABLE 1
Example of the corresponding relationship between the outputs
of the utility function and the probabilities of the communication
device serving as the first-type communication device

| Output of the utility | Probability of the communication device serving |
|---|---|
| function | as the first-type communication device |
| x1 | 10% |
| x2 | 20% |
| x3 | 50% |

In Table 1, when the output of the utility function is x1, the probability of the communication device serving as the first-type communication device is 10%; when the output of the utility function is x2, the probability of the communication device serving as the first-type communication device is 20%; and when the output of the utility function is x3, the probability of the communication device serving as the first-type communication device is 50%.

As another example, the following Table 2 shows another example of the corresponding relationship between the outputs of the utility function and the probabilities of the communication device serving as the first-type communication device.

TABLE 2
Another example of the corresponding relationship between the outputs
of the utility function and the probabilities of the communication
device serving as the first-type communication device

| Output of the utility | Probability of the communication device serving |
|---|---|
| function | as the first-type communication device |
| [x1, x2) | 10% |
| [x2, x3) | 20% |
| [x3, x4] | 50% |

In Table 2, when the output of the utility function falls in the interval [x1, x2) (also called the range x1˜x2), the probability of the communication device serving as the first-type communication device is 10%; when the output of the utility function falls in the interval [x2, x3), the probability of the communication device serving as the first-type communication device is 20%; and when the output of the utility function falls in the interval [x3, x4], the probability of the communication device serving as the first-type communication device is 50%.

Although it is described above that, when the probability of the communication device serving as the first-type communication device is acquired based on the utility function, the probability of the communication device serving as the first-type communication device may be determined by the corresponding relationship between the probabilities of the communication device serving as the first-type communication device and the outputs of the utility function, the present disclosure is not limited thereto. According to other examples, when the probability of the communication device serving as the first-type communication device is acquired based on the utility function, the probability of the communication device serving as the first-type communication device may be directly calculated with the utility function, that is, the output of the utility function may be the probability of the communication device serving as the first-type communication device.

In addition, various methods for acquiring a probability of a communication device serving as the first-type communication device have been described above. It should be understood that, for a plurality of communication devices, probabilities of various communication device serving as the first-type communication device may be acquired respectively by adopting a same method. Alternatively, the probabilities of various communication devices serving as the first-type communication device may also be acquired respectively by adopting different acquisition methods for different communication devices.

It should be appreciated that, in addition to the various methods described above for acquiring a probability of a communication device serving as the first-type communication device, the present disclosure may further include any other methods for acquiring a probability of a communication device serving as the first-type communication device.

In addition, in the first implementation, after the communication device acquires its own probability of serving as the first-type communication device (that is, step S201), in step S202, the communication device determines whether the communication device can serve as a first-type communication device at least according to the first parameter. Specifically, the communication device determining whether the communication device can serve as a first-type communication device at least according to the first parameter may include: determining an actual probability of the communication device serving as the first-type communication device; and when the actual probability is greater than or equal to the probability acquired in step S201, determining that the communication device can serve as a first-type communication device, and when the actual probability is less than the probability acquired in step S201, determining that the communication device cannot serve as a first-type communication device.

According to one example of the first implementation, the attribute information of the communication device described above may be out of date. Therefore, when determining whether the communication device can serve as a first-type communication device, the communication device may determine its actual probability of serving as the first-type communication device based on real-time attribute information. For example, the communication device may determine its actual probability of serving as the first-type communication device based on a current speed. For example, when the speed of the communication device is high speed (for example, greater than 120 km/h), the actual probability of the communication device serving as the first-type communication device may be 50%; when the speed of the communication device is medium speed (for example, greater than 60 km/h and less than 120 km/h), the actual probability of the communication device serving as the first-type communication device may be 70%; when the speed of the communication device is low speed (for example, less than 60 km/h), the actual probability of the communication device serving as the first-type communication device may be 30%. In addition, the communication device may also determine its actual probability of serving as the first-type communication device according to a current channel condition. For example, when the channel condition of the communication device is good, the actual probability of the communication device serving as the first-type communication device may be high, such as 70%; when the channel condition of the communication device is poor, the actual probability of the communication device serving as the first-type communication device may be low, such as 30%.

In addition, in the first implementation, when it is determined in step S202 that the communication device can serve as a first-type communication device, the method 200 may further include: transmitting notification information to proximity communication devices of the communication device, to notify the proximity communication devices that the communication device serves as a first-type communication device.

For example, the communication device may transmit the notification information through low layer signaling such as physical layer signaling, Sidelink Control Information (SCI), and Downlink Control Information (DCI). As another example, the communication device may transmit the notification information through high layer signaling such as Radio Resource Control (RRC) signaling or Media Access Control (MAC) Control Elements (CEs).

In addition, the communication device may transmit the notification information through a Physical Sidelink Control Channel (PSCCH)/Physical Sidelink Share Channel (PSSCH). In this case, the used resources may be determined according to a sidelink resource allocation mechanism. In addition, the communication device may also transmit the notification information through a Sidelink Synchronization Signal (SLSS)/Physical Sidelink Broadcast Channel (PSBCH). In this case, the notification information may be transmitted by using SLSS/PSBCH transmission occasions.

It should be understood that although in the above example, it is only described that the communication device transmits the notification information to its proximity communication devices, the present disclosure is not limited thereto. According to other examples, the communication device may also transmit other information to the proximity communication devices. For example, the communication device may transmit synchronization signals, discovery assistance signals and so on by using SLSS/PSBCH transmission occasions.

In addition, in the first implementation, when it is determined in step S202 that the communication device cannot serve as a first-type communication device, the method 200 may further include: detecting whether there is a first-type communication device in a proximity area of the communication device. In the present disclosure, the area where the proximity communication devices of the communication device are located may be regarded as the proximity area of the communication device. For example, the proximity area may be an area containing one or more proximity communication devices of the communication device.

For example, the communication device may detect whether there is a first-type communication device in its proximity area by whether it receives the notification information from the first-type communication device. As another example, the communication device may detect whether there is a first-type communication device in its proximity area by detecting a discovery signal.

According to a second implementation of the first embodiment of the present disclosure, the first parameter may be a back-off time for the communication device to serve as a first-type communication device.

According to one example of the second implementation, the back-off time may be a back-off time defined by communication standard protocol specifications such as 3GPP and the like. For example, the back-off time may be 10 ms, 50 ms or 100 ms.

According to another example of the second implementation, the back-off time may also be a (pre)configured back-off time. For example, the back-off time may be written into a SIM card of the communication device, or configured by the base station after the communication device accesses the base station. For example, the back-off time may be 10 ms, 50 ms or 100 ms.

According to another example of the second implementation, the back-off time may be a back-off time selected from a back-off time range defined by communication standard protocol specifications such as 3GPP and the like or a (pre)configured back-off time range. For example, the communication device may randomly select a back-off time from the back-off time range as the back-off time for the communication device to serve as a first-type communication device. For example, the back-off time range may be 10 ms˜100 ms, and the communication device may select 40 ms from the back-off time range as the back-off time for the communication device to serve as a first-type communication device.

According to another example of the second implementation, the back-off time may be acquired based on a preset rule. The preset rule may be a preset function, such as a utility function. An input of the utility function may be the attribute information of the communication device, and an output of the utility function may be associated with the back-off time. The attribute information of the communication device mentioned herein is similar to the attribute information of the communication device mentioned in the first implementation, and will not be repeatedly described herein.

In the second implementation, when the back-off time for the communication device to serve as a first-type communication device is acquired based on the utility function, the back-off time for the communication device to serve as a first-type communication device may have a corresponding relationship with the output of the utility function. Therefore, after the output of the utility function is determined, the back-off time for the communication device to serve as a first-type communication device may be acquired by the corresponding relationship between the two.

Specifically, the output of the utility function may be determined firstly according to the above formula (1). Then, according to the corresponding relationship between the outputs of the utility function and the back-off times for the communication device to serve as a first-type communication device, the back-off time for the communication device to serve as a first-type communication device may be determined. For example, the corresponding relationship between the outputs of the utility function and the back-off times for the communication device to serve as a first-type communication device may be predefined.

In addition, the corresponding relationship between the outputs of the utility function and the back-off times for the communication device to serve as a first-type communication device may be stored in the communication device in the form of a table. Therefore, the communication device may determine its back-off time for serving as the first-type communication device by looking up the table after determining the output of the utility function. For example, the following Table 3 shows an example of the corresponding relationship between the outputs of the utility function and the back-off times for the communication device to serve as a first-type communication device.

TABLE 3
Example of the corresponding relationship between the outputs
of the utility function and the back-off times for the communication
device to serve as a first-type communication device

| Output of the utility | Back-off time for the communication device to serve |
|---|---|
| function | as a first-type communication device |
| x1 | 100 ms |
| x2 | 50 ms |
| x3 | 10 ms |

In Table 3, when the output of the utility function is x1, the back-off time for the communication device to serve as a first-type communication device is 100 ms; when the output of the utility function is x2, the back-off time for the communication device to serve as a first-type communication device is 50 ms; and when the output of the utility function is x3, the back-off time for the communication device to serve as a first-type communication device is 10 ms.

As another example, the following Table 4 shows another example of the corresponding relationship between the outputs of the utility function and the back-off times for the communication device to serve as a first-type communication device.

TABLE 4
Another example of the corresponding relationship between the outputs
of the utility function and the back-off times for the communication
device to serve as a first-type communication device

| Output of the utility | Back-off time for the communication device to serve |
|---|---|
| function | as a first-type communication device |
| [x1, x2) | 100 ms |
| [x2, x3) | 50 ms |
| [x3, x4] | 10 ms |

In Table 4, when the output of the utility function falls in the interval [x1, x2), the back-off time for the communication device to serve as a first-type communication device is 100 ms; when the output of the utility function falls in the interval [x2, x3), the back-off time for the communication device to serve as a first-type communication device is 50 ms; and when the output of the utility function falls in the interval [x3, x4], the back-off time for the communication device to serve as a first-type communication device is 10 ms.

Although it is described above that, when the back-off time for the communication device to serve as a first-type communication device is acquired based on the utility function, the back-off time for the communication device to serve as a first-type communication device may be determined by the corresponding relationship between the back-off times for the communication device to serve as a first-type communication device and the outputs of the utility function, the present disclosure is not limited thereto. According to other examples, when the back-off time for the communication device to serve as a first-type communication device is acquired based on the utility function, the back-off time for the communication device to serve as a first-type communication device may be directly calculated with the utility function, that is, the output of the utility function may be the back-off time for the communication device to serve as a first-type communication device.

In addition, various methods for acquiring a back-off time for a communication device to serve as a first-type communication device have been described above. It should be understood that, for a plurality of communication devices, back-off times for various communication devices to serve as a first-type communication device may be acquired respectively by adopting a same method. Alternatively, the back-off times for various communication devices to serve as a first-type communication device may also be acquired respectively by adopting different acquisition methods for different communication devices.

It should be appreciated that, in addition to the various methods described above for acquiring a back-off time for a communication device to serve as a first-type communication device, the present disclosure may further include any other methods for acquiring a back-off time for a communication device to serve as a first-type communication device.

In addition, in the second implementation, after the communication device acquires its back-off time for serving as the first-type communication device (i.e., step S201), in step S202, the communication device determines whether the communication device can serve as a first-type communication device at least according to the first parameter. Specifically, the communication device determining whether the communication device can serve as a first-type communication device at least according to the first parameter may include: when the back-off time is reduced to zero, determining that the communication device can serve as a first-type communication device. In this implementation, when the communication device volunteers to be the first-type communication device, the communication device cannot serve as a first-type communication device immediately, but can serve as a first-type communication device only after a period of time corresponding to the back-off time.

According to one example of the second implementation, when the communication device volunteers to be the first-type communication device, the back-off time for the communication device starts to be reduced. For example, the back-off time may be reduced according to a defined/(pre)configured granularity, for example, a specific step length may be reduced every other granularity. The granularity mentioned herein may be a specific time period (in seconds or milliseconds), Transmission Time Interval (TTI), symbol, time slot, mini-slot, subframe, frame, SLSS/PSBCH transmission occasion. How to reduce the back-off time for the communication device will be described below by taking TTI as an example.

For example, in the case where the back-off time is 100 ms and the specific step length is 20 ms, after the first TTI, the back-off time is reduced and is reduced to 80 ms; after the second TTI, the back-off time continues to be reduced and is reduced to 60 ms; after the third TTI, the back-off time continues to be reduced and is reduced to 40 ms; after the fourth TTI, the back-off time continues to be reduced and is reduced to 20 ms; and after the fifth TTI, the back-off time continues to be reduced and is reduced to 0.

In addition, in the second implementation, after the communication device acquires its back-off time for serving as the first-type communication device (i.e., step S201), in step S202, the communication device determining whether the communication device can serve as a first-type communication device at least according to the first parameter may include: when the communication device receives notification information from the first-type communication device before the back-off time is reduced to zero, determining that the communication device cannot serve as a first-type communication device. As will be described below, when a certain communication device can serve as a first-type communication device, it may notify other communication devices of the message that it serves as a first-type communication device. Therefore, before the back-off time is reduced to zero, when the notification information from the first-type communication device is received during a period of time from the starting of reducing back-off time starts to the back-off time being reduced to zero, it means that there is already another communication device serving as the first-type communication device, and thus the communication device cannot serve as a first-type communication device.

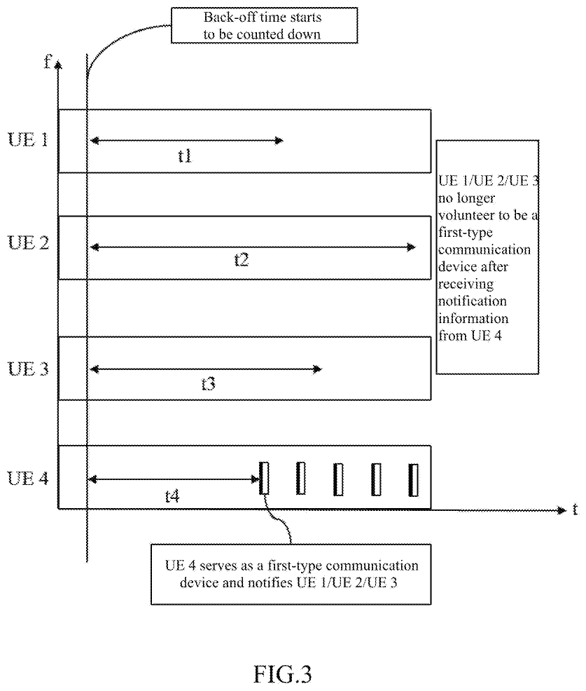

A specific example of determining whether the communication device can serve as a first-type communication device according to the second implementation will be described below with reference to FIG. 3. FIG. 3 is a schematic diagram of determining whether the communication device can serve as a first-type communication device according to the second implementation of the first embodiment of the present disclosure. As shown in FIG. 3, it is assumed that the first communication device (UE 1), the second communication device (UE 2), the third communication device (UE 3), and the fourth communication device (UE 4) all volunteer to be the first-type communication device, and the first communication device, the second communication device, the third communication device, and the fourth communication device each have a back-off time. For example, the back-off time t4 for the fourth communication device<the back-off time t1 for the first communication device<the back-off time t3 for the third communication device<the back-off time t2 for the second communication device.

For the fourth communication device, in step S201, the back-off time t4 for the fourth communication device to serve as a first-type communication device is acquired; and in step S202, when the back-off time t4 is reduced to zero, the fourth communication device can serve as a first-type communication device. Therefore, after step S202, the fourth communication device serves as a first-type communication device, and may notify the first, second, and third communication devices of the information that it serves as a first-type communication device.

For the first communication device, in step S201, the back-off time t1 for the first communication device to serve as a first-type communication device is acquired; and in step S202, when the back-off time t1 is reduced to zero, and the notification information is received before the back-off time t1 is reduced to zero, the first communication device cannot serve as a first-type communication device. Therefore, after step S202, the first communication device no longer tries to serve as a first-type communication device, but can serve as a second-type communication device. The second and third communication devices are similar to the first communication device and will not be repeatedly described herein.

In addition, in the second implementation, according to one example of the second implementation, when it is determined in step S202 that the communication device can serve as a first-type communication device, the method 200 may further include: transmitting notification information to proximity communication devices of the communication device, to notify the proximity communication devices that the communication device serves as a first-type communication device. In addition, according to another example of the second implementation, when it is determined in step S202 that the communication device can serve as a first-type communication device, the method 200 may further include: detecting whether there is a first-type communication device in a proximity area of the communication device. This is similar to the first implementation, and will not be repeatedly described herein.

With the first embodiment of the present disclosure, a probability or back-off time for a communication device to serve as a first-type communication device may be set, so as to increase randomness or restriction on the communication device volunteering to be the first-type communication device, thereby reducing a possibility that a plurality of communication devices volunteer to be the first-type communication device at the same time, avoiding as much as possible the situation where a plurality of communication devices simultaneously serving as the first-type communication device, and realizing determination of one communication device from the plurality of communication devices to serve as a first-type communication device.

A method performed by a communication device according to a second embodiment of the present disclosure will be described below with reference to FIG. 4.

FIG. 4 is a flowchart of a method 400 performed by a communication device according to the second embodiment of the present disclosure. As shown in FIG. 4, in step S401, the communication device acquires a first parameter, so that the communication device determines whether it can serve as a first-type communication device according to the first parameter, where the first-type communication device is used to control a second-type communication device. For example, the first parameter may be attribute information of the communication device.

The attribute information of the communication device mentioned herein may include identification information of the communication device, for example, one or more of ID of the communication device, Service Set Identifier (SSID), Radio Network Temporary Identity (RNTI) and the like.

Furthermore, the attribute information of the communication device may also include movement information of the communication device, for example, one or more of an average speed, a maximum speed and the like of the communication device.

Furthermore, the attribute information of the communication device may also include location information of the communication device, for example, one or more of a geographic location (such as an absolute location or an area ID, etc.) of the communication device, a relative location between the communication device and a proximity communication device that does not belong to any communication device group, an average distance between the communication device and proximity communication devices that do not belong to any communication device group, and the like. In the present disclosure, the proximity communication device may be determined by the communication device performing signal measurement on another communication device. For example, the communication device performs signal measurement on another communication device to obtain a measurement result (for example, signal received quality), and when the measurement result is greater than a first threshold, the another communication device may be the proximity communication device of the communication device. In addition, the proximity communication device may also be determined according to locations of the communication device and another communication device. For example, when a linear distance between the communication device and another communication device is less than a predetermined threshold, the another communication device may be the proximity communication device of the communication device.

Furthermore, the attribute information of the communication device may also include a measurement/sensing result of the communication device on a proximity communication device that does not belong to any communication device group. The measurement/sensing result may be, for example, one or more of Reference Signal Receiving Power (RSRP), Received Signal Strength Indication (RSSI), Reference Signal Receiving Quality (RSRQ), Signal to Interference plus Noise Ratio (SINR), Signal to Noise Ratio (SNR) and the like.

Furthermore, the attribute information of the communication device may also include information about the number of proximity communication devices that do not belong to any communication device group, for example, information about the number of proximity communication devices that do not belong to any communication device group during a predetermined period of time.

Furthermore, the attribute information of the communication device may also include priority information for the communication device to serve as a first-type communication device. For example, a priority may be defined based on a determination manner of the first-type communication device. For example, when the first-type communication device is determined through high layer signaling, the priority for the communication device to serve as a first-type communication device may be set to 1; when the first-type communication device is (pre)configured, the priority for the communication device to serve as a first-type communication device may be set to 2; when the first-type communication device is automatically selected, the priority for the communication device to serve as may be set to 3.

Furthermore, the attribute information of the communication device may also include class information of the communication device, for example, a class identifier of the communication device, such as a class identifier of the communication device belonging to a bus, a truck, a car or the like.

It should be appreciated that although the above examples describe that the attribute information of the communication device may include the identification information of the communication device, the movement information of the communication device, the location information of the communication device, the measurement/sensing result of the communication device on a proximity communication device that does not belong to any communication device group, the information about the number of proximity communication devices that do not belong to any communication device group, the priority information for the communication device to serve as a first-type communication device, or the class information of the communication device, the present disclosure is not limited thereto. According to other examples, the attribute information of the communication device may also include any other attribute information of the communication device.

According to one example of the second embodiment of the present disclosure, the attribute information of the communication device may be stored in a memory of the communication device. Accordingly, in step S401, the communication device acquiring the first parameter may include the communication device reading its own attribute information from its own memory. In this example, after the communication device acquires its own attribute information, the method 400 may further include: the communication device transmitting its own attribute information to other communication devices, so that the other communication devices may determine whether it can serve as a first-type communication device.

Then, in step S402, the communication device receives a second parameter from other communication devices. Alternatively, step S402 may also be performed before step S401, or simultaneously with step S401. The second parameter may be attribute information of the other communication devices, for example. The attribute information of the other communication devices is similar to the attribute information of the communication device described above, and will not be repeatedly described herein.

According to one example of the second embodiment of the present disclosure, when other communication devices volunteer to be the first-type communication device, the other communication devices may transmit their own attribute information to the communication device. For example, the other communication devices may broadcast their own attribute information according to a defined/(pre)configured packet transmission quantity/duration and packet interval. Accordingly, the communication device may receive the attribute information of the other communication devices from the other communication devices according to the defined/(pre)configured packet transmission quantity/duration time and packet interval.

In addition, according to another example of the second embodiment of the present disclosure, regardless of whether other communication devices volunteer to be the first type communication device, the other communication devices may periodically transmit their own attribute information. For example, the other communication devices may periodically broadcast their own attribute information. Accordingly, the communication device may periodically receive the attribute information of the other communication devices from the other communication devices.

In addition, according to another example of the second embodiment of the present disclosure, the other communication devices may transmit their own attribute information through low layer signaling such as physical layer signaling, Sidelink Control Information (SCI), and Downlink Control Information (DCI). Alternatively, the other communication devices may transmit their own attribute information through high layer signaling such as Radio Resource Control (RRC) signaling or Media Access Control (MAC) Control Elements (CEs). Accordingly, the communication device may receive the attribute information of the other communication devices from the other communication devices through low layer signaling or high layer signaling.

In addition, according to another example of the second embodiment of the present disclosure, the other communication devices may transmit their own attribute information through a Physical Sidelink Control Channel (PSCCH)/Physical Sidelink Share Channel (PSSCH). In addition, the other communication devices may transmit their own attribute information through a Sidelink Synchronization Signal (SLSS)/Physical Sidelink Broadcast Channel (PSBCH). In addition, the other communication devices may transmit their own attribute information through other sidelink channels. Accordingly, the communication device may receive the attribute information of the other communication devices from the other communication devices through PSCCH/PSSCH, SLSS/PSBCH or other sidelink channels.

In addition, according to another example of the second embodiment of the present disclosure, before the communication device volunteers to be the first-type communication device, the communication device may monitor the second parameters received from the other communication devices within a defined/(pre)configured period of time. In this way, it may be ensured that the communication device and the other communication devices have sufficient time to exchange their parameters, so as to determine the most suitable first-type communication device from the communication device and the other communication devices.

Then, in step S403, the communication device determines whether the communication device can serve as a first-type communication device according to the first parameter and the second parameter. For example, the communication device may determine whether the communication device can serve as a first-type communication device according to the first parameter, the second parameter, and a preset rule. The preset rule may be, for example, selecting a communication device with a largest or smallest attribute to serve as a first-type communication device.

According to one example of the second embodiment of the present disclosure, when the attribute information of the communication device includes identification information of the communication device, and the attribute information of the other communication devices includes identification information of the other communication devices, the communication device determining whether the communication device can serve as a first-type communication device according to the first parameter and the second parameter may include: when an identification value of the communication device is greater than identification values of the other communication devices, determining that the communication device can serve as a first-type communication device. Alternatively, when the attribute information of the communication device includes the identification information of the communication device, the communication device determining whether the communication device can serve as a first-type communication device according to the first parameter and the second parameter may include: when the identification value of the communication device is less than the identification values of the other communication devices, determining that the communication device can serve as a first-type communication device.

According to another example of the second embodiment of the present disclosure, when the attribute information of the communication device includes priority information for the communication device to serve as a first-type communication device, and the attribute information for the other communication devices includes the priority information for the other communication devices to serve as first-type communication devices, the communication device determining whether the communication device can serve as a first-type communication device according to the first parameter and the second parameter may include: when a priority for the communication device is greater than priorities for the other communication devices, determining that the communication device can serve as a first-type communication device.

According to another example of the second embodiment of the present disclosure, the communication device determining whether the communication device can serve as a first-type communication device according to the first parameter and the second parameter may include: determining a priority for the communication device to serve as a first-type communication device according to the attribute information of the communication device, and determining priorities for the other communication devices to serve as first-type communication devices according to the attribute information of the other communication devices; and when the priority for the communication device to serve as a first-type communication device is greater than the priorities for the other communication devices to serve as first-type communication devices, determining that the communication device can serve as a first-type communication device.

In this example, determining the priority for the communication device to serve as a first-type communication device according to the attribute information of the communication device may be determining the priority for the communication device to serve as a first-type communication device according to the attribute information of the communication device and a utility function for the communication device. An input of the utility function may be the attribute information of the communication device, and an output of the utility function may be associated with the priority. For example, the priority for the communication device to serve as a first-type communication device may have a corresponding relationship with the output of the utility function. Therefore, after the output of the utility function is determined, the priority for the communication device to serve as a first-type communication device may be acquired by the corresponding relationship between the two.

Specifically, the output of the utility function may be determined firstly according to the following formula (2):

U=α˜ƒ(ν)+b·ƒ(SNR) Formula (2)

wherein α and b represent weight parameters, ν represent a speed of the communication device, ƒ(ν) represents a function about the speed of the communication device, SNR represents a signal-to-noise ratio measured by the communication device to a proximity communication device, and ƒ(SNR) represents a function about the SNR of the communication device. It should be appreciated that although in the above formula (2), only the speed of the communication device and the signal-to-noise ratio measured by the communication device to a proximity communication device are used as inputs of the utility function, the present disclosure is not limited thereto. According to other examples, one or more other attributes of the communication device may also be used as inputs of the utility function. For example, the identification of the communication device, the class of the communication device and the like may also be used as inputs of the utility function.

Then, the priority for the communication device to serve as a first-type communication device may be determined according to the corresponding relationship between the outputs of the utility function and the priorities for the communication device to serve as a first-type communication device. For example, the corresponding relationship between the outputs of the utility function and the priorities for the communication device to serve as a first-type communication device may be predefined.

In addition, the corresponding relationship between the outputs of the utility function and the priorities for the communication device to serve as a first-type communication device may be stored in the communication device in the form of a table. Therefore, the communication device may determine its priority of serving as the first-type communication device by looking up the table after determining the output of the utility function. For example, the following Table 5 shows an example of the corresponding relationship between the outputs of the utility function and the priorities for the communication device to serve as a first-type communication device.

TABLE 5
Example of the corresponding relationship between the outputs
of the utility function and the priorities for the communication
device to serve as a first-type communication device

| Output of the utility | Priority for the communication device to serve |
|---|---|
| function | as a first-type communication device |
| x1 | 1 |
| x2 | 2 |
| x3 | 3 |

In Table 5, when the output of the utility function is x1, the priority for the communication device to serve as a first-type communication device is 1; when the output of the utility function is x2, the priority for the communication device to serve as a first-type communication device is 2; and when the output of the utility function is x3, the priority for the communication device to serve as a first-type communication device is 3.

As another example, the following Table 6 shows another example of the corresponding relationship between the outputs of the utility function and the priorities for the communication device to serve as a first-type communication device.

TABLE 6
Another example of the corresponding relationship between the
outputs of the utility function and the priorities for the communication
device to serve as a first-type communication device

| Output of the utility | Priority for the communication device to serve |
|---|---|
| function | as a first-type communication device |
| [x1, x2) | 1 |
| [x2, x3) | 2 |
| [x3, x4] | 3 |

In Table 6, when the output of the utility function falls in the interval [x1, x2) (also called the range x1˜x2), the priority for the communication device to serve as a first-type communication device is 1; when the output of the utility function falls in the interval [x2, x3), the priority for the communication device to serve as a first-type communication device is 2; and when the output of the utility function falls in the interval [x3, x4], the priority for the communication device to serve as a first-type communication device is 3.

Although it is described above that, the priority for the communication device to serve as a first-type communication device is determined by the corresponding relationship between the priorities for the communication device to serve as a first-type communication device and the outputs of the utility function, the present disclosure is not limited thereto. According to other examples, the priority for the communication device to serve as a first-type communication device may be directly calculated with the utility function, that is, the output of the utility function may be the priority for the communication device to serve as a first-type communication device.

In addition, it should be appreciated that, although the example in which a communication device with the largest identification or priority of the attributes is selected as the first-type communication device is described above, the present disclosure is not limited thereto. According to other examples, a communication device with other largest or smallest attributes may also be selected as the first-type communication device. For example, a communication device with the largest number of proximity communication devices may be selected as the first-type communication device. As another example, a communication device with the smallest average distance from proximity communication devices may be selected as the first-type communication device.

In addition, when it is determined in step S403 that the communication device can serve as a first-type communication device, the method 400 may further include: transmitting notification information to proximity communication devices of the communication device, to notify the proximity communication devices that the communication device serves as a first-type communication device.

For example, the communication device may transmit the notification information through low layer signaling such as physical layer signaling, Sidelink Control Information (SCI), and Downlink Control Information (DCI). As another example, the communication device may transmit the notification information through high layer signaling such as Radio Resource Control (RRC) signaling or Media Access Control (MAC) Control Elements (CEs).

In addition, the communication device may transmit the notification information through a Physical Sidelink Control Channel (PSCCH)/Physical Sidelink Share Channel (PSSCH). In this case, the used resources may be determined according to a sidelink resource allocation mechanism. In addition, the communication device may also transmit the notification information through a Sidelink Synchronization Signal (SLSS)/Physical Sidelink Broadcast Channel (PSBCH). In this case, the notification information may be transmitted by using SLSS/PSBCH transmission occasions.

It should be understood that although in the above example, it is only described that the communication device transmits the notification information to its proximity communication devices, the present disclosure is not limited thereto. According to other examples, the communication device may also transmit other information to the proximity communication devices. For example, the communication device may transmit synchronization signals, discovery assistance signals and so on by using SLSS/PSBCH transmission occasions.

In addition, when it is determined in step S403 that the communication device cannot serve as a first-type communication device, the method 400 may further include: detecting whether there is a first-type communication device in a proximity area of the communication device. In the present disclosure, the area where the proximity communication devices of the communication device are located may be regarded as the proximity area of the communication device.

For example, the communication device may detect whether there is a first-type communication device in its proximity area by whether it receives the notification information from the first-type communication device. As another example, the communication device may detect whether there is a first-type communication device in its proximity area by detecting a discovery signal.

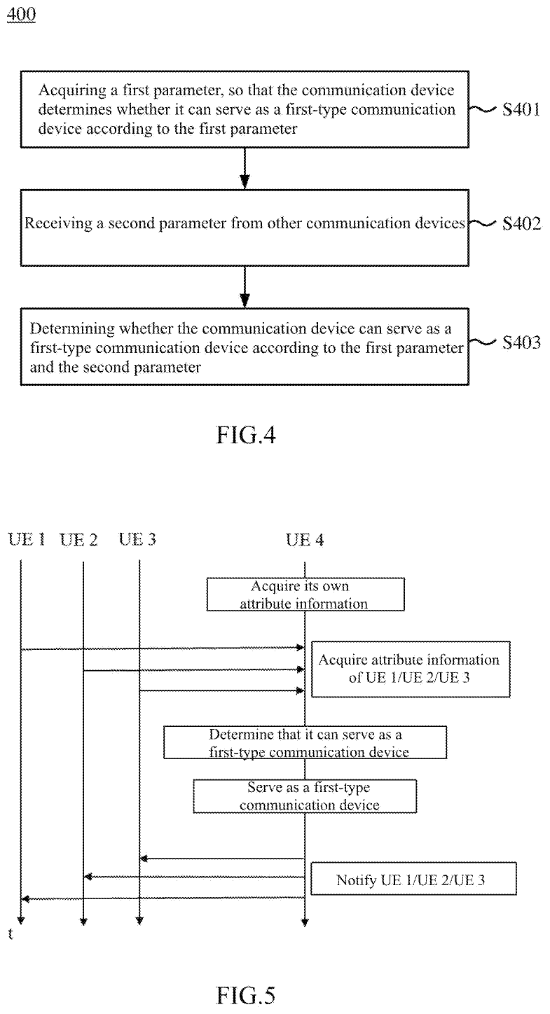

A specific example of determining whether the communication device can serve as a first-type communication device according to the second embodiment will be described below with reference to FIG. 5. FIG. 5 is a schematic diagram of determining whether the communication device can serve as a first-type communication device according to the second embodiment of the present disclosure. As shown in FIG. 5, it is assumed that the first communication device (UE 1), the second communication device (UE 2), the third communication device (UE 3), and the fourth communication device (UE 4) all volunteer to be the first-type communication device, and the fourth communication device performs the method 400. In step S401, the fourth communication device acquires its own attribute information; in step S402, the fourth communication device acquires attribute information of the first, second, and third communication devices from the first, second, and third communication devices; and in step S403, the fourth communication device determines whether it can serve as a first-type communication device according to its own attribute information and the attribute information of the first, second, and third communication devices. When it is determined in step S403 that the fourth communication device can serve as a first-type communication device, the fourth communication device serves as a first-type communication device, and the fourth communication device may transmit notification information to the first, second, and third communication devices, to notify the first, second, and third communication devices of the information that it serves as a first-type communication device. Accordingly, after receiving the notification information of the fourth communication device, the first, second, and third communication devices may no longer try to serve as a first-type communication device, but may serve as second-type communication devices.

With the second embodiment of the present disclosure, information used to assist in determining a first-type communication device between communication devices may be exchanged, so that a communication device determines whether it can serve as a first-type communication device by comparison, so as to increase randomness or restriction on the communication device volunteering to be the first-type communication device, thereby reducing a possibility that a plurality of communication devices volunteer to be the first-type communication device at the same time, avoiding as much as possible the situation where a plurality of communication devices simultaneously serving as the first-type communication device, and realizing determination of one communication device from the plurality of communication devices to serve as a first-type communication device.

According to a third embodiment of the present disclosure, when a communication device volunteers to be the first-type communication device, the communication device serves as a first-type communication device. In addition, after the communication device volunteers to be the first-type communication device, the communication device may transmit notification information to its proximity communication devices, to notify the proximity communication devices that the communication device serves as a first-type communication device. Accordingly, when receiving the notification information from the first-type communication device, the proximity communication devices of the communication device no longer try to serve as a first-type communication device, but may serve as second-type communication devices.

In the third embodiment, at a certain moment, there may be a situation where a plurality of communication devices serve as a first-type communication device at the same time. In this situation, problems caused by this situation may be solved by other mechanisms. For example, the problems caused by this situation may be solved by a resource allocation mechanism, a regrouping rule for communication device groups, and so on.

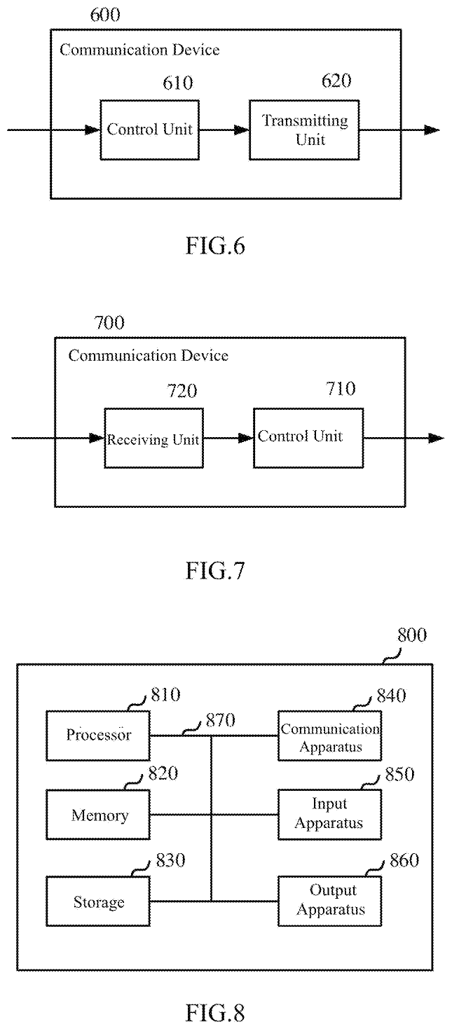

A communication device according to the first embodiment of the present disclosure will be described below with reference to FIG. 6. FIG. 6 is a schematic structural diagram of a communication device 600 according to the first embodiment of the present disclosure. Since functions of the communication device 600 are the same as the details of the method described above with reference to FIG. 2, a detailed description of the same content is omitted herein for the sake of simplicity. As shown in FIG. 6, the communication device 600 includes: a control unit 610 configured to acquire a first parameter, so that the communication device determines whether it can serve as a first-type communication device according to the first parameter, where the first-type communication device is used to control a second-type communication device; and the control unit 610 is further configured to determine whether the communication device can serve as a first type communication device at least according to the first parameter. In addition to this unit, the communication device 600 may further include other components. However, since these components are not related to the content of the embodiments of the present disclosure, illustration and description thereof are omitted herein.

According to a first implementation of the first embodiment of the present disclosure, the first parameter may be a probability (or may also be referred to as a probability value) of the communication device serving as the first-type communication device.

According to one example of the first implementation, the probability may be a probability defined by communication standard protocol specifications such as 3GPP and the like.

According to another example of the first implementation, the probability may also be a (pre)configured probability. For example, the probability may be written into a SIM card of the communication device, or a probability configured by a base station after the communication device accesses the base station.

According to another example of the first implementation, the probability may be a probability selected from a probability range defined by communication standard protocol specifications such as 3GPP and the like or a (pre)configured probability range. For example, the communication device may randomly select a probability from the probability range as the probability of the communication device serving as the first-type communication device.

According to another example of the first implementation, the probability may be acquired based on a preset rule. The preset rule may be a preset function for the communication device, such as a utility function. An input of the utility function may be attribute information of the communication device, and an output of the utility function may be associated with the probability.

In the first implementation, when the probability of the communication device serving as the first-type communication device is acquired based on the utility function, the probability of the communication device serving as the first-type communication device may have a corresponding relationship with the output of the utility function. Therefore, after the output of the utility function is determined, the probability of the communication device serving as the first-type communication device may be acquired by the corresponding relationship between the two.

Specifically, the output of the utility function may be determined firstly according to the above formula (1). Then, the probability of the communication device serving as the first-type communication device may be determined according to the corresponding relationship between the outputs of the utility function and the probabilities of the communication device serving as the first-type communication device. For example, the corresponding relationship between the outputs of the utility function and the probabilities of the communication device serving as the first-type communication device may be predefined, and thus the probability of the communication device serving as the first-type communication device may be determined by the output of the utility function and the corresponding relationship.

In addition, the corresponding relationship between the outputs of the utility function and the probabilities of the communication device serving as the first-type communication device may be stored in the communication device in the form of a table. Therefore, the communication device may determine its probability of serving as the first-type communication device by looking up the table after determining the output of the utility function.

In addition, in the first implementation, after the control unit 610 acquires its own probability of serving as the first-type communication device, the control unit 610 determines whether the communication device can serve as a first-type communication device at least according to the first parameter. Specifically, the control unit 610 may determine an actual probability of the communication device serving as the first-type communication device; and when the actual probability is greater than or equal to the acquired probability, determine that the communication device can serve as a first-type communication device, and when the actual probability is less than the acquired probability, determine that the communication device cannot serve as a first-type communication device.

According to one example of the first implementation, the attribute information of the communication device described above may be out of date. Therefore, when determining whether the communication device can serve as a first-type communication device, the control unit 610 may determine its actual probability of serving as the first-type communication device based on real-time attribute information.

In addition, in the first implementation, when the control unit 610 determines that the communication device can serve as a first-type communication device, the communication device 600 may further include a transmitting unit 620 configured to transmit notification information to proximity communication devices of the communication device, to notify the proximity communication devices that the communication device serves as a first-type communication device.

For example, the communication device may transmit the notification information through low layer signaling such as physical layer signaling, Sidelink Control Information (SCI), and Downlink Control Information (DCI). As another example, the communication device may transmit the notification information through high layer signaling such as Radio Resource Control (RRC) signaling or Media Access Control (MAC) Control Elements (CEs).

In addition, the communication device may transmit the notification information through a Physical Sidelink Control Channel (PSCCH)/Physical Sidelink Share Channel (PSSCH). In this case, the resources used may be determined according to a sidelink resource allocation mechanism. In addition, the communication device may also transmit the notification information through a Sidelink Synchronization Signal (SLSS)/Physical Sidelink Broadcast Channel (PSBCH). In this case, the notification information may be transmitted by using SLSS/PSBCH transmission occasions.

In addition, in the first implementation, when the control unit 610 determines that the communication device cannot serve as a first-type communication device, the control unit 610 may further detect whether there is a first-type communication device in a proximity area of the communication device. In the present disclosure, the area where the proximity communication devices of the communication device are located may be regarded as the proximity area of the communication device. For example, the proximity area may be an area containing one or more proximity communication devices of the communication device.

For example, the communication device may detect whether there is a first-type communication device in its proximity area by whether it receives the notification information from the first-type communication device. As another example, the communication device may detect whether there is a first-type communication device in its proximity area by detecting a discovery signal.

According to a second implementation of the first embodiment of the present disclosure, the first parameter may be a back-off time for the communication device to serve as a first-type communication device.

According to one example of the second implementation, the back-off time may be a back-off time defined by communication standard protocol specifications such as 3GPP and the like.

According to another example of the second implementation, the back-off time may also be a (pre)configured back-off time. For example, the back-off time may be written into a SIM card of the communication device, or configured by the base station after the communication device accesses the base station.

According to another example of the second implementation, the back-off time may be a back-off time selected from a back-off time range defined by communication standard protocol specifications such as 3GPP and the like or a (pre)configured back-off time range. For example, the communication device may randomly select a back-off time from the back-off time range as the back-off time for the communication device to serve as a first-type communication device.

According to another example of the second implementation, the back-off time may be acquired based on a preset rule. The preset rule may be a preset function, such as a utility function. An input of the utility function may be the attribute information of the communication device, and an output of the utility function may be associated with the back-off time. The attribute information of the communication device mentioned herein is similar to the attribute information of the communication device mentioned in the first implementation, and will not be repeatedly described herein.

In the second implementation, when the back-off time for the communication device to serve as a first-type communication device is acquired based on the utility function, the back-off time for the communication device to serve as a first-type communication device may have a corresponding relationship with the output of the utility function. Therefore, after the output of the utility function is determined, the back-off time for the communication device to serve as a first-type communication device may be acquired by the corresponding relationship between the two.

Specifically, the output of the utility function may be determined firstly according to the above formula (1). Then, according to the corresponding relationship between the outputs of the utility function and the back-off times for the communication device to serve as a first-type communication device, the back-off time for the communication device to serve as a first-type communication device may be determined. For example, the corresponding relationship between the outputs of the utility function and the back-off times for the communication device to serve as a first-type communication device may be predefined.

In addition, the corresponding relationship between the outputs of the utility function and the back-off times for the communication device to serve as a first-type communication device may be stored in the communication device in the form of a table. Therefore, the communication device may determine its back-off time for serving as the first-type communication device by looking up the table after determining the output of the utility function.

In addition, in the second implementation, after the control unit 610 acquires its back-off time for serving as the first-type communication device, the control unit 610 determines whether the communication device can serve as a first-type communication device at least according to the first parameter. Specifically, the control unit 610 may determine that the communication device can serve as a first-type communication device when the back-off time is reduced to zero. In this implementation, when the communication device volunteers to be the first-type communication device, the communication device cannot serve as a first-type communication device immediately, but can serve as a first-type communication device only after a period of time corresponding to the back-off time.

According to one example of the second implementation, when the communication device volunteers to be the first-type communication device, the back-off time for the communication device starts to be reduced. For example, the back-off time may be reduced according to a defined/(pre)configured granularity, for example, a specific step length may be reduced every other granularity. The granularity mentioned herein may be a specific time period (in seconds or milliseconds), Transmission Time Interval (TTI), symbol, time slot, mini-slot, subframe, frame, SLSS/PSBCH transmission occasion. How to reduce the back-off time for the communication device will be described below by taking TTI as an example.

In addition, in the second implementation, after the control unit 610 acquires its back-off time for serving as the first-type communication device, the control unit 610 determines whether the communication device can serve as a first-type communication device at least according to the first parameter. Specifically, the control unit 610 may also determine that the communication device cannot serve as a first-type communication device when the communication device receives notification information from the first-type communication device before the back-off time is reduced to zero. As will be described below, when a certain communication device can serve as a first-type communication device, it may notify other communication devices of the message that it serves as a first-type communication device. Therefore, before the back-off time is reduced to zero, when the notification information from the first-type communication device is received during a period of time from the starting of reducing back-off time starts to the back-off time being reduced to zero, it means that there is already another communication device serving as the first-type communication device, and thus the communication device cannot serve as a first-type communication device.

In addition, in the second implementation, according to one example of the second implementation, when control unit 610 determines that the communication device can serve as a first-type communication device, the communication device 600 may further include a transmitting unit 620 configured to transmit notification information to proximity communication devices of the communication device, to notify the proximity communication devices that the communication device serves as a first-type communication device. In addition, according to another example of the second implementation, when the control unit 610 determines that the communication device can serve as a first-type communication device, the control unit 610 may further detect whether there is a first-type communication device in a proximity area of the communication device. This is similar to the first implementation, and will not be repeatedly described herein.

With the communication device according to the first embodiment of the present disclosure, a probability or back-off time for the communication device to serve as a first-type communication device may be set, so as to increase randomness or restriction on the communication device volunteering to be the first-type communication device, thereby reducing a possibility that a plurality of communication devices volunteer to be the first-type communication device at the same time, avoiding as much as possible the situation where a plurality of communication devices simultaneously serving as the first-type communication device, and realizing determination of one communication device from the plurality of communication devices to serve as a first-type communication device.

A communication device according to the second embodiment of the present disclosure will be described below with reference to FIG. 7. FIG. 7 is a schematic structural diagram of a communication device 700 according to the second embodiment of the present disclosure. Since functions of the communication device 700 are the same as the details of the method described above with reference to FIG. 4, a detailed description of the same content is omitted herein for the sake of simplicity. As shown in FIG. 7, the communication device 700 includes: a control unit 710 configured to acquire a first parameter, so that the communication device determines whether it can serve as a first-type communication device according to the first parameter, where the first-type communication device is used to control a second-type communication device; and a receiving unit 720 configured to receive a second parameter from other communication devices, the control unit 710 is further configured to determine whether the communication device can serve as a first type communication device according to the first parameter and the second parameter. In addition to these two units, the communication device 700 may further include other components. However, since these components are not related to the content of the embodiments of the present disclosure, illustration and description thereof are omitted herein.

According to one example of the present disclosure, the first parameter may be the attribute information of the communication device. The attribute information of the communication device may be stored in a memory of the communication device. Accordingly, the control unit 710 may include reading its own attribute information from its own memory. In this example, after the communication device acquires its own attribute information, the communication device 700 may further include a transmitting unit (not shown in the figure) configured to transmit its own attribute information to other communication devices, so that the other communication devices may determine whether they can serve as a first-type communication device.

According to one example of the present disclosure, the second parameter may be attribute information of other communication devices, for example. The attribute information of the other communication devices is similar to the attribute information of the communication device described above, and will not be repeatedly described herein.

According to one example of the second embodiment of the present disclosure, when other communication devices volunteer to be the first-type communication device, the other communication devices may transmit their own attribute information to the communication device. For example, the other communication devices may broadcast their own attribute information according to a defined/(pre)configured packet transmission quantity/duration and packet interval. Accordingly, the receiving unit 720 may receive the attribute information of the other communication devices from the other communication devices according to the defined/(pre)configured packet transmission quantity/duration time and packet interval.

In addition, according to another example of the second embodiment of the present disclosure, regardless of whether other communication devices volunteer to be the first type communication device, the other communication devices may periodically transmit their own attribute information. Accordingly, the receiving unit 720 may periodically receive the attribute information of the other communication devices from the other communication devices.

In addition, according to another example of the second embodiment of the present disclosure, the other communication devices may transmit their own attribute information through low layer signaling such as physical layer signaling, Sidelink Control Information (SCI), and Downlink Control Information (DCI). Alternatively, the other communication devices may transmit their own attribute information through high layer signaling such as Radio Resource Control (RRC) signaling or Media Access Control (MAC) Control Elements (CEs). Accordingly, the receiving unit 720 may receive the attribute information of the other communication devices from the other communication devices through low layer signaling or high layer signaling.

In addition, according to another example of the second embodiment of the present disclosure, the other communication devices may transmit their own attribute information through a Physical Sidelink Control Channel (PSCCH)/Physical Sidelink Share Channel (PSSCH). In addition, the other communication devices may transmit their own attribute information through a Sidelink Synchronization Signal (SLSS)/Physical Sidelink Broadcast Channel (PSBCH). In addition, the other communication devices may transmit their own attribute information through other sidelink channels. Accordingly, the receiving unit 720 may receive the attribute information of the other communication devices from the other communication devices through PSCCH/PSSCH, SLSS/PSBCH or other sidelink channels.

In addition, according to another example of the second embodiment of the present disclosure, before the communication device volunteers to be the first-type communication device, the communication device may monitor the second parameters received from the other communication devices within a defined/(pre)configured period of time. In this way, it may be ensured that the communication device and the other communication devices have sufficient time to exchange their parameters, so as to determine the most suitable first-type communication device from the communication device and the other communication devices.

According to one example of the second embodiment of the present disclosure, the control unit 710 may determine whether the communication device can serve as a first-type communication device according to the first parameter, the second parameter, and a preset rule. The preset rule may be, for example, selecting a communication device with a largest or smallest attribute to serve as a first-type communication device.

According to one example of the second embodiment of the present disclosure, when the attribute information of the communication device includes identification information of the communication device, and the attribute information of the other communication devices includes identification information of the other communication devices, the control unit 710 may determine that the communication device can serve as a first-type communication device when an identification value of the communication device is greater than identification values of the other communication devices. Alternatively, when the attribute information of the communication device includes the identification information of the communication device, the control unit 710 may determine that the communication device can serve as a first-type communication device when the identification value of the communication device is less than the identification values of the other communication devices.

According to another example of the second embodiment of the present disclosure, when the attribute information of the communication device includes priority information for the communication device to serve as a first-type communication device, and the attribute information for the other communication devices includes the priority information for the other communication devices to serve as a first-type communication device, the control unit 710 may determine that the communication device can serve as a first-type communication device when a priority for the communication device is greater than priorities for the other communication devices.

According to another example of the second embodiment of the present disclosure, the control unit 710 may determine a priority for the communication device to serve as a first-type communication device according to the attribute information of the communication device, and determine priorities for the other communication devices to serve as first-type communication devices according to the attribute information of the other communication devices; and when the priority for the communication device to serve as a first-type communication device is greater than the priorities for the other communication devices to serve as first-type communication devices, determine that the communication device can serve as a first-type communication device.

In this example, determining the priority for the communication device to serve as a first-type communication device according to the attribute information of the communication device may be determining the priority for the communication device to serve as a first-type communication device according to the attribute information of the communication device and a utility function for the communication device. An input of the utility function may be the attribute information of the communication device, and an output of the utility function may be associated with the priority. For example, the priority for the communication device to serve as a first-type communication device may have a corresponding relationship with the output of the utility function. Therefore, after the output of the utility function is determined, the priority for the communication device to serve as a first-type communication device may be acquired by the corresponding relationship between the two.

Specifically, the output of the utility function may be determined firstly according to the above formula (2). Then, the priority for the communication device to serve as a first-type communication device may be determined according to the corresponding relationship between the outputs of the utility function and the priorities for the communication device to serve as a first-type communication device. For example, the corresponding relationship between the outputs of the utility function and the priorities for the communication device to serve as a first-type communication device may be predefined.

In addition, the corresponding relationship between the outputs of the utility function and the priorities for the communication device to serve as a first-type communication device may be stored in the communication device in the form of a table. Therefore, the communication device may determine its priority of serving as the first-type communication device by looking up the table after determining the output of the utility function.

In addition, the transmitting unit may also transmit notification information to proximity communication devices of the communication device, to notify the proximity communication devices that the communication device serves as a first-type communication device.

In addition, when the control unit 710 determines that the communication device cannot serve as a first-type communication device, the control unit 710 may further detect whether there is a first-type communication device in a proximity area of the communication device. In the present disclosure, the area where the proximity communication devices of the communication device are located may be regarded as the proximity area of the communication device.

With the communication device according to the second embodiment of the present disclosure, information used to assist in determining a first-type communication device between communication devices may be exchanged, so that a communication device determines whether it can serve as a first-type communication device by comparison, so as to increase randomness or restriction on the communication device volunteering to be the first-type communication device, thereby reducing a possibility that a plurality of communication devices volunteer to be the first-type communication device at the same time, avoiding as much as possible the situation where a plurality of communication devices simultaneously serving as the first-type communication device, and realizing determination of one communication device from the plurality of communication devices to serve as a first-type communication device.

<Hardware Structure>

In addition, block diagrams used in the description of the above embodiments illustrate blocks in units of functions. These functional blocks (structural blocks) may be implemented in arbitrary combination of hardware and/or software. Furthermore, means for implementing respective functional blocks is not particularly limited. That is, the respective functional blocks may be implemented by one apparatus that is physically and/or logically jointed; or more than two apparatuses that are physically and/or logically separated may be directly and/or indirectly connected (e.g. via wire and/or wireless), and the respective functional blocks may be implemented by these apparatuses.

For example, a device (such as, the first communication device, the second communication device, the aerial user terminal, etc.) in an embodiment of the present disclosure may function as a computer that executes the processes of the wireless communication method of the present disclosure. FIG. 8 is a schematic diagram of a hardware structure of a device 800 involved in an embodiment of the present disclosure. The above device 800 may be constituted as a computer apparatus that physically comprises a processor 810, a memory 820, a storage 830, a communication apparatus 840, an input apparatus 850, an output apparatus 860, a bus 870 and the like

In addition, in the following description, terms such as “apparatus” may be replaced with circuits, devices, units, and the like. The hardware structure of the user terminal and the base station may include one or more of the respective apparatuses shown in the figure, or may not include a part of the apparatuses.

For example, only one processor 810 is illustrated, but there may be multiple processors. Furthermore, processes may be performed by one processor, or processes may be performed by more than one processor simultaneously, sequentially, or by other methods. In addition, the processor 810 may be installed by more than one chip.

Respective functions of any of the device 800 may be implemented, for example, by reading specified software (program) on hardware such as the processor 810 and the memory 820, so that the processor 810 performs computations, controls communication performed by the communication apparatus 840, and controls reading and/or writing of data in the memory 820 and the storage 830.

The processor 810, for example, operates an operating system to control the entire computer. The processor 810 may be constituted by a Central Processing Unit (CPU), which includes interfaces with peripheral apparatuses, a control apparatus, a computing apparatus, a register and the like. For example, the determining unit, the adjusting unit and the like described above may be implemented by the processor 810.

In addition, the processor 810 reads programs (program codes), software modules and data from the storage 830 and/or the communication apparatus 840 to the memory 820, and execute various processes according to them. As for the program, a program causing computers to execute at least a part of the operations described in the above embodiments may be employed. For example, the determining unit of the user terminal 500 may be implemented by a control program stored in the memory 820 and operated by the processor 810, and other functional blocks may also be implemented similarly.

The memory 820 is a computer-readable recording medium, and may be constituted, for example, by at least one of a Read Only Memory (ROM), an Erasable Programmable ROM (EPROM), an Electrically EPROM (EEPROM), a Random Access Memory (RAM) and other appropriate storage media. The memory 820 may also be referred to as a register, a cache, a main memory (a main storage apparatus) and the like. The memory 820 may store executable programs (program codes), software modules and the like for implementing a method involved in an embodiment of the present disclosure.

The storage 830 is a computer-readable recording medium, and may be constituted, for example, by at least one of a flexible disk, a floppy® disk, a magneto-optical disk (e.g., a Compact Disc ROM (CD-ROM) and the like), a digital versatile disk, a Blu-ray® disk, a removable disk, a hard driver, a smart card, a flash memory device (e.g., a card, a stick and a key driver), a magnetic stripe, a database, a server, and other appropriate storage media. The storage 830 may also be referred to as an auxiliary storage apparatus.

The communication apparatus 840 is a hardware (transceiver device) performing communication between computers via a wired and/or wireless network, and is also referred to as a network device, a network controller, a network card, a communication module and the like, for example. The communication device 840 may include a high-frequency switch, a duplexer, a filter, a frequency synthesizer and the like to implement, for example, Frequency Division Duplex (FDD) and/or Time Division Duplex (TDD). For example, the transmitting unit, the receiving unit and the like described above may be implemented by the communication apparatus 840.

The input apparatus 850 is an input device (e.g., a keyboard, a mouse, a microphone, a switch, a button, a sensor and the like) that receives input from the outside. The output apparatus 860 is an output device (e.g., a display, a speaker, a Light Emitting Diode (LED) light and the like) that performs outputting to the outside. In addition, the input apparatus 850 and the output apparatus 860 may also be an integrated structure (e.g., a touch screen).

Furthermore, the respective apparatuses such as the processor 810 and the memory 820 are connected by the bus 870 that communicates information. The bus 870 may be constituted by a single bus or by different buses between the apparatuses.

Furthermore, the base station and the user terminal may comprise hardware such as a microprocessor, a Digital Signal Processor (DSP), an Application Specified Integrated Circuit (ASIC), a Programmable Logic Device (PLD), a Field Programmable Gate Array (FPGA), etc., and the hardware may be used to implement a part of or all of the respective functional blocks. For example, the processor 810 may be installed by at least one of these hardware.

(Variations)

In addition, the embodiments described above may be used in combination. In addition, the terms illustrated in the present specification and/or the terms required for understanding of the present specification may be substituted with terms having the same or similar meaning. For example, a channel and/or a symbol may also be a signal (signaling). Furthermore, the signal may be a message. A reference signal may be abbreviated as an “RS”, and may also be referred to as a pilot, a pilot signal and so on, depending on the standard applied. Furthermore, a component carrier (CC) may also be referred to as a cell, a frequency carrier, a carrier frequency, and the like.

Furthermore, the information, parameters and so on described in this specification may be represented in absolute values or in relative values with respect to specified values, or may be represented by other corresponding information. For example, radio resources may be indicated by specified indexes. Furthermore, formulas and the like using these parameters may be different from those explicitly disclosed in this specification.

The names used for the parameters and the like in this specification are not limited in any respect. For example, since various channels (Physical Uplink Control Channels (PUCCHs), Physical Downlink Control Channels (PDCCHs), etc.) and information elements may be identified by any suitable names, the various names assigned to these various channels and information elements are not limitative in any respect.

The information, signals and the like described in this specification may be represented by using any one of various different technologies. For example, data, instructions, commands, information, signals, bits, symbols, chips, etc. possibly referenced throughout the above description may be represented by voltages, currents, electromagnetic waves, magnetic fields or particles, optical fields or photons, or any combination thereof.

In addition, information, signals and the like may be output from higher layers to lower layers and/or from lower layers to higher layers. Information, signals and the like may be input or output via a plurality of network nodes.

The information, signals and the like that are input or output may be stored in a specific location (for example, in a memory), or may be managed in a control table. The information, signals and the like that are input or output may be overwritten, updated or appended. The information, signals and the like that are output may be deleted. The information, signals and the like that are input may be transmitted to other apparatuses.

Reporting of information is by no means limited to the manners/embodiments described in this specification, and may be implemented by other methods as well. For example, reporting of information may be implemented by using physical layer signaling (for example, downlink control information (DCI), uplink control information (UCI)), higher layer signaling (for example, RRC (Radio Resource Control) signaling, broadcast information (master information blocks (MIBs), system information blocks (SIBs), etc.), MAC (Medium Access Control) signaling), other signals or combinations thereof.

In addition, physical layer signaling may also be referred to as L1/L2 (Layer 1/Layer 2) control information (L1/L2 control signals), L1 control information (L1 control signal) and the like. Furthermore, RRC signaling may also be referred to as RRC messages, for example, RRC connection setup messages, RRC connection reconfiguration messages, and so on. Furthermore, MAC signaling may be reported by using, for example, MAC control elements (MAC CEs).

Furthermore, notification of prescribed information (for example, notification of “being X”) is not limited to being performed explicitly, and may be performed implicitly (for example, by not performing notification of the prescribed information or by notification of other information).

Decision may be performed by a value (0 or 1) represented by 1 bit, or by a true or false value (Boolean value) represented by TRUE or FALSE, or by a numerical comparison (e.g., comparison with a prescribed value).

Software, whether referred to as “software”, “firmware”, “middleware”, “microcode” or “hardware description language”, or called by other names, should be interpreted broadly to mean instructions, instruction sets, code, code segments, program codes, programs, subprograms, software modules, applications, software applications, software packages, routines, subroutines, objects, executable files, execution threads, procedures, functions and so on.

In addition, software, commands, information, etc. may be transmitted and received via a transport medium. For example, when software is transmitted from web pages, servers or other remote sources using wired technologies (coaxial cables, fibers, twisted pairs, Digital Subscriber Lines (DSLs), etc.) and/or wireless technologies (infrared ray, microwave, etc.), these wired technologies and/or wireless technologies are included in the definition of the transport medium.

The terms “system” and “network” used in this specification may be used interchangeably.

In this specification, terms like “Base Station (BS)”, “wireless base station”, “eNB”, “gNB”, “cell”, “sector”, “cell group”, “carrier” and “component carrier” may be used interchangeably. A base station is sometimes referred to as terms such as a fixed station, a NodeB, an eNodeB (eNB), an access point, a transmitting point, a receiving point, a femto cell, a small cell and the like.

A base station is capable of accommodating one or more (for example, three) cells (also referred to as sectors). In the case where the base station accommodates a plurality of cells, the entire coverage area of the base station may be divided into a plurality of smaller areas, and each smaller area may provide communication services by using a base station sub-system (for example, a small base station for indoor use (a Remote Radio Head (RRH)). Terms like “cell” and “sector” refer to a part of or an entirety of the coverage area of a base station and/or a sub-system of the base station that provides communication services in this coverage.

In this specification, terms such as “Mobile Station (MS)”, “user terminal”, “User Equipment (UE)”, and “terminal” may be used interchangeably. The mobile station is sometimes referred by those skilled in the art as a user station, a mobile unit, a user unit, a wireless unit, a remote unit, a mobile device, a wireless device, a wireless communication device, a remote device, a mobile user station, an access terminal, a mobile terminal, a wireless terminal, a remote terminal, a handset, a user agent, a mobile client, a client, or some other appropriate terms.

Furthermore, a wireless base station in this specification may also be replaced with a user terminal. For example, for a structure in which communication between a wireless base station and a user terminal is replaced with communication between a plurality of user terminals (Device-to-Device, D2D), the respective manners/embodiments of the present disclosure may also be applied. At this time, functions provided by the first communication device and the second communication device of the above device 800 may be regarded as functions provided by a user terminal. Furthermore, the words “uplink” and “downlink” may also be replaced with “side”. For example, an uplink channel may be replaced with a side channel.

Also, a user terminal in this specification may be replaced with a wireless base station. At this time, functions provided by the above user terminal may be regarded as functions provided by the first communication device and the second communication device.

In this specification, specific actions configured to be performed by the base station sometimes may be performed by its upper nodes in certain cases. Obviously, in a network composed of one or more network nodes having base stations, various actions performed for communication with terminals may be performed by the base stations, one or more network nodes other than the base stations (for example, Mobility Management Entities (MMEs), Serving-Gateways (S-GWs), etc., may be considered, but not limited thereto)), or combinations thereof.

The respective manners/embodiments described in this specification may be used individually or in combinations, and may also be switched and used during execution. In addition, orders of processes, sequences, flow charts and so on of the respective manners/embodiments described in this specification may be re-ordered as long as there is no inconsistency. For example, although various methods have been described in this specification with various units of steps in exemplary orders, the specific orders as described are by no means limitative.

The manners/embodiments described in this specification may be applied to systems that utilize Long Term Evolution (LTE), Advanced Long Term Evolution (LTE-A, LTE-Advanced), Beyond Long Term Evolution (LTE-B, LTE-Beyond), the super 3rd generation mobile communication system (SUPER 3G), Advanced International Mobile Telecommunications (IMT-Advanced), the 4th generation mobile communication system (4G), the 5th generation mobile communication system (5G), Future Radio Access (FRA), New Radio Access Technology (New-RAT), New Radio (NR), New radio access (NX), Future generation radio access (FX), Global System for Mobile communications (GSM®), Code Division Multiple Access 3000 (CDMA 3000), Ultra Mobile Broadband (UMB), IEEE 920.11 (Wi-Fi®), IEEE 920.16 (WiMAX®), IEEE 920.20, Ultra-Wide Band (UWB), Bluetooth® and other appropriate wireless communication methods, and/or next-generation systems that are enhanced based on them.

Terms such as “based on” as used in this specification do not mean “based on only”, unless otherwise specified in other paragraphs. In other words, terms such as “based on” mean both “based on only” and “at least based on.”

Any reference to units with designations such as “first”, “second” and so on as used in this specification does not generally limit the quantity or order of these units. These designations may be used in this specification as a convenient method for distinguishing between two or more units. Therefore, reference to a first unit and a second unit does not imply that only two units may be employed, or that the first unit must precedes the second unit in several ways.

Terms such as “deciding (determining)” as used in this specification may encompass a wide variety of actions. The “deciding (determining)” may regard, for example, calculating, computing, processing, deriving, investigating, looking up (e.g., looking up in a table, a database or other data structures), ascertaining, etc. as performing the “deciding (determining)”. In addition, the “deciding (determining)” may also regard receiving (e.g., receiving information), transmitting (e.g., transmitting information), inputting, outputting, accessing (e.g., accessing data in a memory), etc. as performing the “deciding (determining)”. In addition, the “deciding (determining)” may further regard resolving, selecting, choosing, establishing, comparing, etc. as performing the “deciding (determining)”. That is to say, the “deciding (determining)” may regard certain actions as performing the “deciding (determining)”.

As used herein, terms such as “connected”, “coupled”, or any variation thereof mean any direct or indirect connection or coupling between two or more units, and may include the presence of one or more intermediate units between two units that are “connected” or “coupled” to each other. Coupling or connection between the units may be physical, logical or a combination thereof. For example, “connection” may be replaced with “access.” As used in this specification, two units may be considered as being “connected” or “coupled” to each other by using one or more electrical wires, cables and/or printed electrical connections, and, as a number of non-limiting and non-inclusive examples, by using electromagnetic energy having wavelengths in the radio frequency region, microwave region and/or optical (both visible and invisible) region.

When terms such as “including”, “comprising” and variations thereof are used in this specification or the claims, these terms, similar to the term “having”, are also intended to be inclusive. Furthermore, the term “or” as used in this specification or the claims is not an exclusive or.

Although the present disclosure has been described above in detail, it should be obvious to a person skilled in the art that the present disclosure is by no means limited to the embodiments described in this specification. The present disclosure may be implemented with various modifications and alterations without departing from the spirit and scope of the present disclosure defined by the recitations of the claims. Consequently, the description in this specification is for the purpose of illustration, and does not have any limitative meaning to the present disclosure.

1. A terminal, comprising:
a control unit configured to acquire a first parameter, so that the terminal determines whether it can serve as a first-type terminal according to the first parameter, the first-type terminal being used to control a second-type terminal;
the control unit being further configured to determine whether the terminal can serve as a first-type terminal at least according to the first parameter.

2. The terminal of claim 1, wherein the first parameter is a probability of the terminal serving as a first-type terminal.

3. The terminal of claim 1, wherein the first parameter is a back-off time for the terminal to serve as a first-type terminal.

4. The terminal of claim 3, wherein the control unit is further configured to determine that the terminal can serve as a first-type terminal when the back-off time is reduced to zero.

5. The terminal of claim 3, wherein the control unit is further configured to determine that the terminal cannot serve as a first-type terminal when the terminal receives notification information from a first-type terminal before the back-off time is reduced to zero.

6. The terminal of claim 1, further comprising:
a transmitting unit configured to transmit notification information to proximity terminals of the terminal, to notify the proximity terminals that the terminal serves as a first-type terminal.

7. The terminal of claim 1, further comprising:
a receiving unit configured to receive a second parameter from other terminals;
the control unit being further configured to determine whether the terminal can serve as a first-type terminal according to the first parameter and the second parameter.

8. The terminal of claim 7, wherein the first parameter is attribute information of the terminal, and the second parameter is attribute information of the other terminals.

9. The terminal of claim 8, wherein when the attribute information of the terminal includes identification information of the terminal, the control unit is further configured to determine that the terminal can serve as a first-type terminal when an identification value of the terminal is greater than identification values of the other terminals, or when the identification value of the terminal is less than the identification values of the other terminals.

10. The terminal of claim 8, wherein the control unit is further configured to determine a priority for the communication device to serve as a first-type terminal according to the attribute information of the terminal, and determine priorities for the other terminals to serve as first-type terminals according to the attribute information of the other terminals; and determine that the terminal can serve as a first-type terminal when the priority for the communication device to serve as a first-type terminal is greater than the priorities for the other terminals to serve as first-type terminals.

11. A method performed by a terminal, the method comprising:
acquiring a first parameter, so that the terminal determines whether it can serve as a first-type terminal according to the first parameter, the first-type terminal being used to control a second-type terminal; and
determining whether the terminal can serve as a first-type terminal at least according to the first parameter.

12. The method of claim 11, further comprising:
receiving a second parameter from other terminals;
wherein the determining whether the terminal can serve as a first-type terminal at least according to the first parameter includes:
determining whether the terminal can serve as a first-type terminal according to the first parameter and the second parameter.
